(19) United States
(12) Patent Application Publication
(10) Pub. No.: US 2013/0114823 A1
(43) Pub. Date: May 9, 2013

(54) Headset With Proximity Determination

(71) Applicants: Juhani V. Kari, Lieto (FI); Pasi M. Koskinen, Paimio (FI)

(72) Inventors: Juhani V. Kari, Lieto (FI); Pasi M. Koskinen, Paimio (FI)

(73) Assignee: Nokia Corporation

(21) Appl. No.: 13/289,138

(22) Filed: Nov. 4, 2011

(51) Int. Cl. H04R 1/10

(52) U.S. Cl. 381/74

(57) ABSTRACT

An apparatus including a housing configured to support the apparatus on a head of a user; a controller; a sound transducer; and a proximity detector. The proximity detector is connected to the controller. The controller is configured to perform a predetermined function based upon a signal from the proximity detector.

### BACKGROUND

1. Technical Field

The exemplary and non-limiting embodiments relate generally to a headset and, more particularly, to a control system in a headset.

2. Brief Description of Prior Developments

Headsets, such as wireless headsets for example, are a class of accessory devices widely used with various portable electronic devices. Wireless headsets enable the user to access audio features of a portable device while the device itself may be stowed away and located at a distance from the user. Example applications of wireless headsets include having a telephone conversation while being engaged in another activity such as driving a car, or listening to music while the device is stowed in a bag or a pocket.

Wireless headset units may comprise audio transducers for capturing and reproducing sound waves, and they are configured for communication with other devices by various methods, such as short-range radio techniques, for example. Various headset devices such as BLUETOOTH headsets are popular accessory products that are designed to improve usability of mobile phones. Wireless headset units may also comprise input controls for controlling various features of the unit, such as one or more buttons for switching the unit ON or OFF, and receiving or ending a call. The units may be monaural or stereophonic, and they may be designed to be worn by the user on the ear, over the head, or in other suitable ways. As consumers demand increased functionality from electronic devices, there is a need to provide improved headset units which allow for an improved user experience by providing for ease of use when performing device actions/operations such as powering ON, connecting to a paired device, and accepting a call for example.

### SUMMARY

The following summary is merely intended to be exemplary. The summary is not intended to limit the scope of the claims.

In accordance with one aspect, an apparatus is provided including a housing configured to support the apparatus on a head of a user; a controller; a sound transducer; and a proximity detector. The proximity detector is connected to the controller. The controller is configured to perform a predetermined function based upon a signal from the proximity detector.

In accordance with another aspect, a method comprises connecting a sound transducer to a controller; connecting a proximity detector to the controller; and assembling the controller, the sound transducer and the proximity detector with a housing to form an apparatus configured to be supported on a head of a user.

In accordance with another aspect, a method comprises sending an electrical signal from a proximity detector to a controller, where the proximity detector is on an apparatus configured to be supported on a head of a user, and where the apparatus comprises a sound transducer; and performing at least one predetermined function by a controller of the apparatus based upon the signal from the proximity detector, where the predetermined function comprises turning the apparatus ON or OFF.

In accordance with another aspect, A non-transitory program storage device readable by a machine, tangibly embodying a program of instructions executable by the machine for performing operations, the operations comprising determining receipt of a signal by a controller of an apparatus from a proximity detector of the apparatus; and turning the apparatus ON or OFF by the controller based upon receipt of the signal by the controller, where the proximity detector and the controller are connected to a housing of the apparatus configured to be supported on a head of a user, and where the controller is configured to at least partially control a sound transducer of the apparatus.

### BRIEF DESCRIPTION OF THE DRAWINGS

The foregoing aspects and other features are explained in the following description, taken in connection with the accompanying drawings, wherein:

FIG. 1 is a diagram illustrating communication connection of an example embodiment to another device;

FIG. 2 is a diagram illustrating components of the example embodiment shown in FIG. 1;

FIG. 3 is a schematic cross sectional view of the example embodiment shown in FIG. 1;

FIG. 4 is a side view of the example embodiment shown in FIG. 1;

FIG. 5 is a diagram illustrating location of a concha portion of the apparatus shown in FIG. 4 in a user's ear;

FIG. 6 is a perspective view of the concha portion of the housing shown in FIG. 4;

FIG. 7 is a diagram illustrating features of a capacitive sensing method;

FIG. 8 is a diagram illustrating features of an example method;

FIG. 9 is a side view of the example embodiment shown in FIG. 4 with the concha portion of the housing removed and replaced with an earbud in-ear housing portion;

FIG. 10 is a diagram illustrating location of the earbud in-ear housing portion of the apparatus shown in FIG. 9 in a user's ear;

FIG. 11 is a diagram illustrating features of an E-field sensing method;

FIG. 12 is a partial schematic cross sectional view similar to FIG. 3 of an alternate example embodiment;

FIG. 13 is a perspective view of a housing member of an alternate example embodiment;

FIG. 14 is a perspective view of another alternate example embodiment

FIG. 15 illustrates an alternate example embodiment;

FIG. 16 illustrates a possible connection for the alternate example embodiment shown in FIG. 15; and

FIG. 17 illustrates a possible connection for the alternate example embodiment shown in FIG. 15.

### DETAILED DESCRIPTION OF EMBODIMENTS

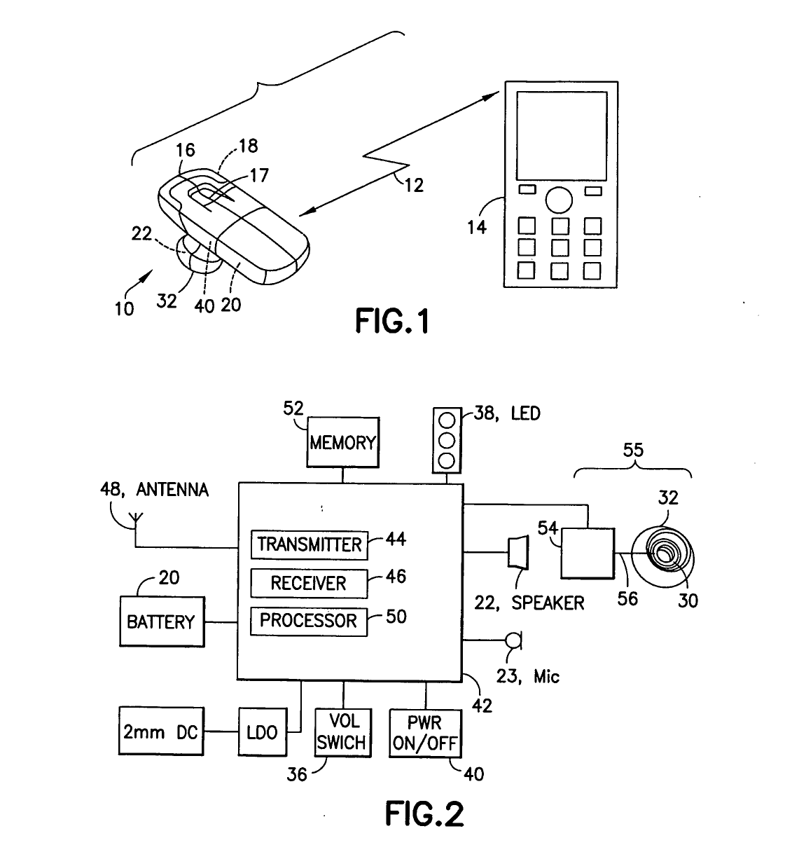

Referring to FIG. 1, there is shown a diagram illustrating an apparatus 10 incorporating features of an example embodiment, capable of a wireless link or connection 12 to a device 14. Although features will be described with reference to the example embodiments shown in the drawings, it should be understood that features can be embodied in many alternate forms of embodiments. In addition, any suitable size, shape or type of elements or materials could be used.

The device 14 is a mobile telephone in this example. The device 14 is able to provide telephone service to a mobile telephone network. The device also has a short range wireless communication function, such as BLUETOOTH for example, to establish the radio frequency link 12 with the apparatus 10. However, in an alternate embodiment any suitable device could be provided for the device 14, such as a music player, PDA, laptop computer, video camera, etc.

The apparatus 10 is a wireless headset which is adapted to be supportably mounted at a person's ear. The apparatus 10 has a housing 16, electronics or electrical components 18 in the housing, and a battery 20 in the housing. The electrical components 18 include a speaker 22, a transmitter and a receiver. The transmitter and receiver can communicate with the device 14 via the link 12. The electronics could also comprise a microphone. Thus, the apparatus 10 can be used with the device 14 for hands-free use of the device 14, such as when driving a vehicle for example.

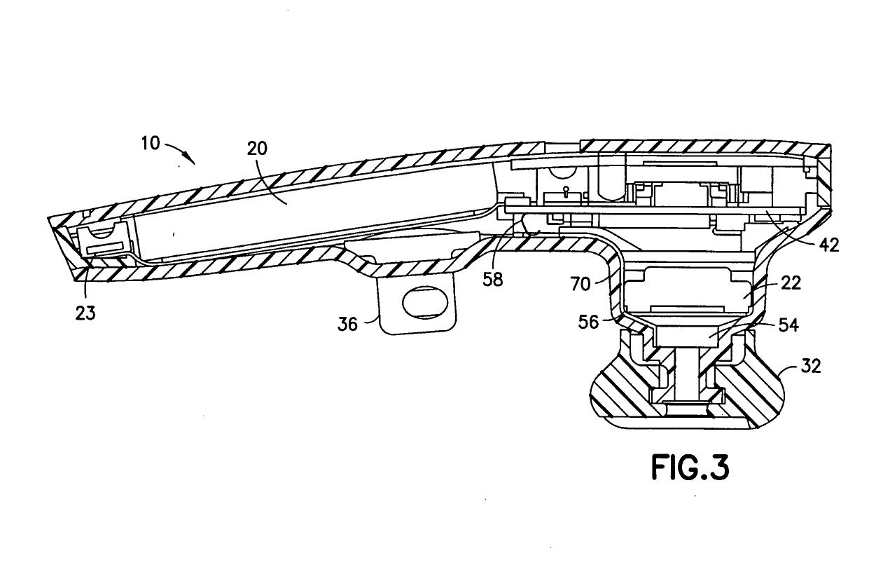

The housing 16 includes a portion 32 which is sized and shaped to be inserted in a person's ear. The speaker 22 is located in this portion 32. Referring also to FIGS. 2 and 3, the electronics or electrical components 18 of the apparatus 10 can comprise at least one printed wiring board (PWB) 42 connected to the speaker 22, the microphone 23 and the battery 20. In this example, the apparatus includes a volume switch 36 and an ON/OFF switch 40 connected to the PWB 42 as well as the transmitter 44, the receiver 46, the controller 50 such as a microprocessor for example, memory 52 and an antenna 48 which could be integrally formed as part of the PWB. The apparatus 10 can also comprise LED signal lights 38.

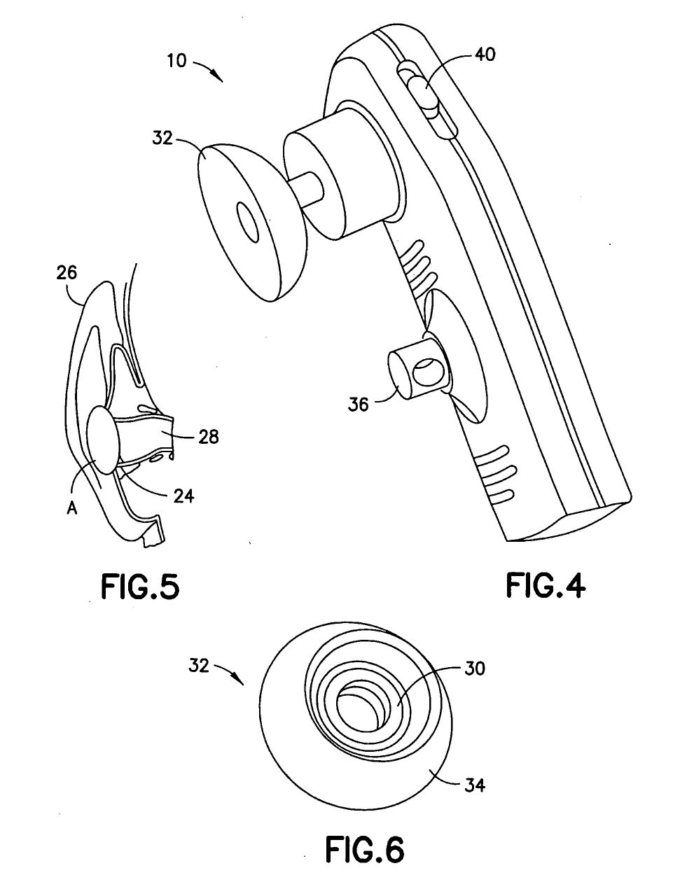

The portion 32 of the housing in this example is a concha portion. As seen in FIG. 5, the concha portion is configured to be inserted into a concha part 24 of an ear 26 of the user proximate the ear canal 28 as indicated by A. Referring also to FIG. 6, the concha portion 32 comprises an electrically conductive member 30 and a non-conductive member 34. As seen in FIG. 2, the apparatus 10 also includes a proximity sensor 54. The proximity sensor 54 is connected to the conductive member 30, such as by a flex circuit 56. In the embodiment shown in FIG. 3, a spring contact 58 connects the flex circuit 56 to the PWB 42. The sensor 54 and conductive member 30 form a proximity detector 55. The proximity sensor 54, in this example, is a capacitive sensor. When the skin of the user touches the conductive member 30 or comes very close to the skin of the user without touching the skin, such as when the portion 32 is inserted into the ear of the user, the sensor 54 sends a signal to the controller 50 on the PWB 42.

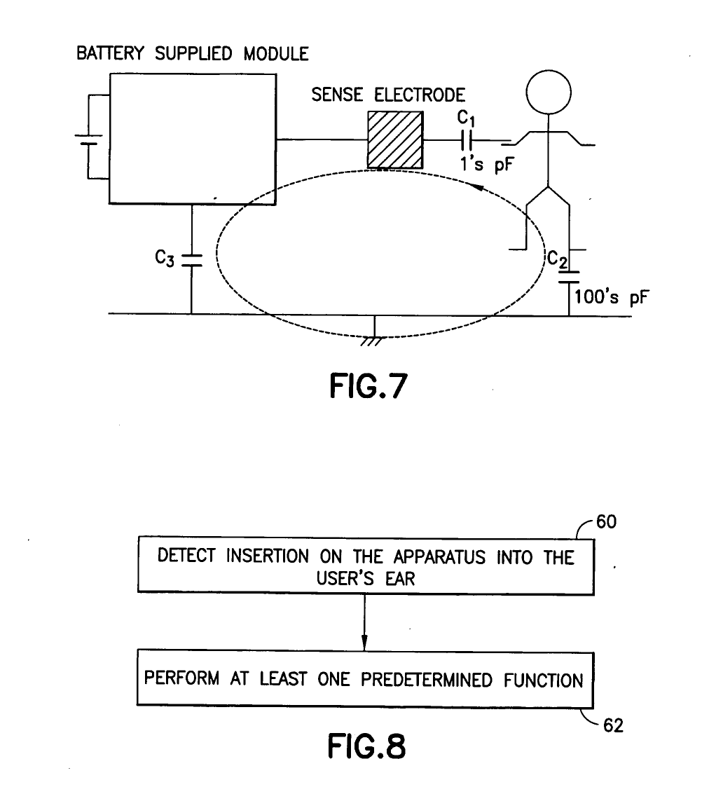

Referring also to FIG. 7, capacitive sensing is a technology based on capacitive coupling that is used in many different types of sensors, including those to detect and measure proximity. Capacitive sensing has been used as a human interface device (HID) technology for example to replace the computer mouse. Capacitive touch sensors are used in many devices such as laptop trackpads, digital audio players, computer displays, mobile phones, mobile devices and others. Capacitive sensors detect anything which is conductive or has a dielectric different than that of air. Capacitive sensing is used in the apparatus 10 to detect when the apparatus has been placed in and/or removed from the user's ear. Capacitive sensing does not require the skin of the user to contact the sensor/electrode. A signal can be sent from the capacitive sensing detector when the skin of the user comes close without touching. Thus, the proximity detector can be configured to send a proximity signal based upon actual contact with the skin and/or coming within a predetermined distance to the skin, such as 2 mm or less for example.

Referring also to FIG. 8, when the user inserts the portion 32 in the ear, the detector detects that insertion as indicated by block 60. The detector then sends a signal to the controller 50, and the controller can perform at least one predetermined function as indicated by block 62. For example, the apparatus could be configured to turn ON when the proximity signal is sent by the detector 55 to the controller 50. As another example, when an incoming call is being received by the device 14, the predetermined function(s) could be, for example, turning the apparatus 10 ON, and sending a signal to the device 14 (via link 12) to answer an incoming call. The apparatus 10 could be configured to have the apparatus 10 in a sleep mode unless the proximity detector senses the portion 32 being located in the user's ear. The ON/OFF switch 40 could, thus, have three settings: OFF, Sleep until proximity detector turns ON, and fully ON which can disregard or override the proximity detector. The use of the proximity detector can combine with software programming from the memory 52 and the hardware of the controller and sensor 54 to perform the functions noted above.

An example of how the apparatus could be used is explained below. The user could turn the switch 40 to a sleep mode. This helps to conserve power of the battery 20 by not continuously having the link 12. The user can leave the apparatus 10 out of the ear, such as on an office desk for example. When the device 14 indicates an incoming call (such as a ring tone or vibrating), the user can merely place the portion 32 in the ear. The proximity detector 55 automatically senses the apparatus being placed in the ear and sends a signal to the controller which turns ON the apparatus 10. The apparatus 10 can automatically establish the link 12 with the device 14, and perhaps also send a signal to the device 14 to answer the incoming call.

In addition to the functions described above, the apparatus could be configured to perform function(s) when the proximity detector 55 indicates that the apparatus 10 has been removed from a user's ear. When the proximity detector determines that the apparatus 10 has been removed from the user's ear, the sensor 54 could send a signal to the controller 50. The apparatus could be configured to put the apparatus in a sleep mode when that signal is received, for example; terminating the link 12 and thereby conserving battery power of the battery 20. An alternative or additional function could be for the apparatus 10 to send a signal to the device 14 to end a telephone call. Thus, the user does not need to press a button on the apparatus 10 to end a telephone call. The user could merely remove the apparatus 10 from the user's ear in order to have the apparatus 10 instruct the device 14 to end the telephone call.

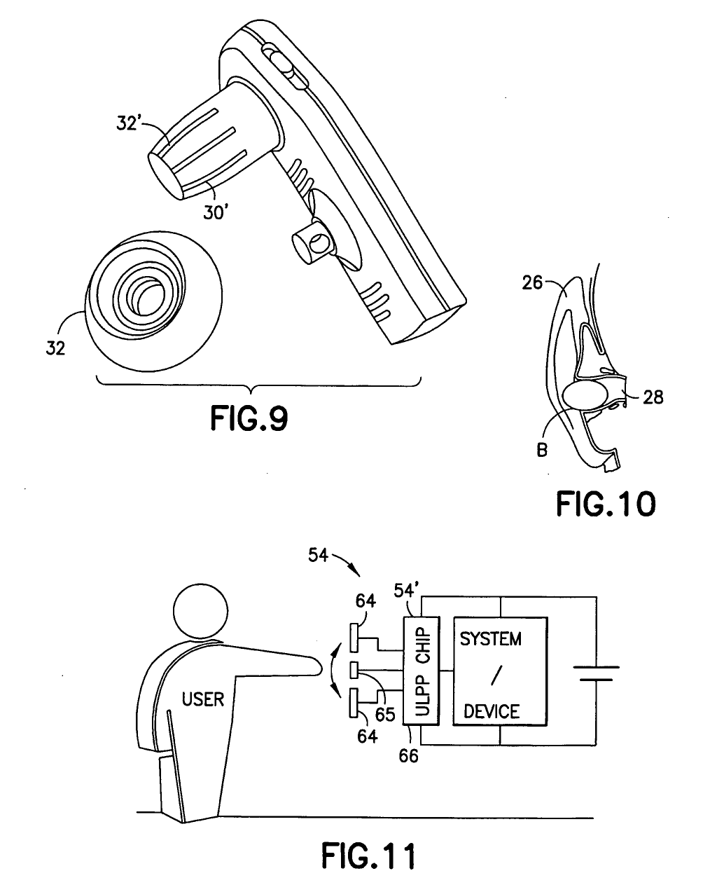

Referring also to FIGS. 9 and 10, the headset 10 could have the concha portion 32 removed and replaced with an in-ear earbud portion 32′. In this case the earbud portion 32′ could comprise electrically conductive portions 30′ which contact the user's skin when inserted in the ear. The electrically conductive portion could be on the exterior surface or covered by a small rubber or polymer layer. With a capacitive sensor, a 1 mm thick plastic can be provided on top of the electrode which corresponds to a conventional cover thickness. As seen in FIG. 10, the earbud portion 32′ can be inserted in the ear canal 28 as indicated by area B.

With a capacitive sensor, good and reliable detection of dielectric materials can be provided. With a capacitive sensor, wearing, corrosion or solvents do not ruin reliability. With a capacitive sensor, no changes are needed to mechanics except for the flex 56 (or the LDS as described below). With a capacitive sensor, there are no changes to audio response.

Referring also to FIG. 11, an alternate embodiment will be described. Rather than the proximity sensor 54 being a capacitive sensor, the proximity sensor could be an E-Field sensor 54′. The proximity detector in this example comprises at least two electrodes 64, 65 and the E-filed sensor 54′. In this example, the E-field sensor 54′ comprises an Ultra Low Power Proximity (ULPP) chip 66. The system uses an electromagnetic field generator powering one of the electrodes, with the other electrode acting as a sensing electrode. The ULPP chip 66 was originally developed for 3-D gesture recognition and control; such as GESTIC technology capable of detecting hand, finger, and body movements without the user having to actually touch the device. The ULPP chip 66 is used to detect proximity of the user to the apparatus. E-Field sensing can provide reliable measurements based on a non-ground based methodology (transmission mode operation). ULPP is stable and reliable with respect to environmental conditions changes (humidity, temperature, earth ground coupling). Because of the extreme low power consumption of typically 2 μA, ULPP can run continuously for a very long time without significant power drain on the battery.

The E-field sensor electrodes can be located under the headset cover part 70. E-field sensor technology can provide good and reliable detection of dielectric material. With an E-Field sensor, wearing, corrosion or solvents do not ruin reliability. With an E-Field sensor, there are no changes needed to mechanics except for the flex 56 (or LDS described below). With an E-Field sensor, there are no changes to audio response

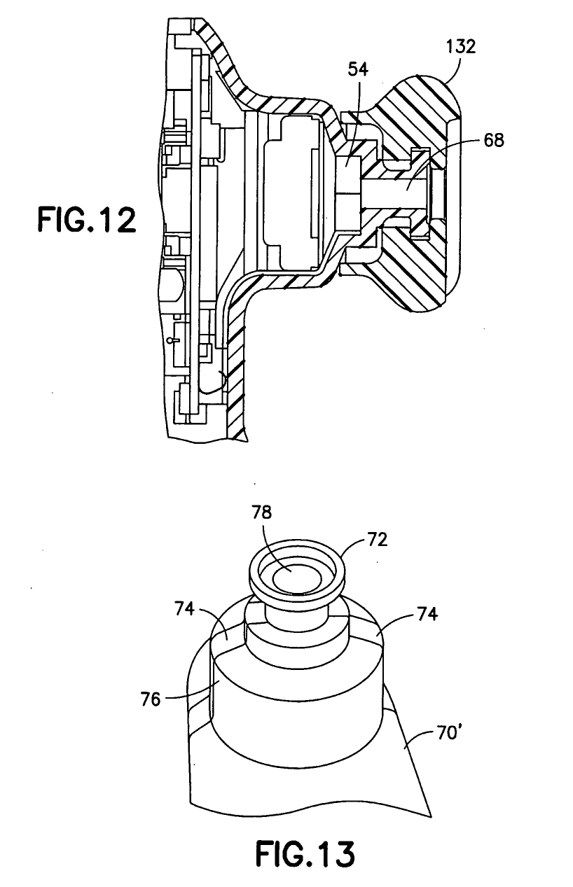

Referring also to FIG. 12, an alternate embodiment is shown where the electrode area for the E-field sensor has been increased to include area 68. The apparatus in this example is almost identical to the apparatus 10 shown in FIG. 3. However, the portion 32 has been replaced with a conventional portion 132. Testing results have indicated that by increasing sensor sensitivity, such as increasing the size of the electrode of sensor 54, material of the earbud (the portion 132) can be a normal TPE/silicon as used in conventional products. In other words, the portion 32 could be a conventional ear portion; not necessarily an ear portion with a conductive member 30. Electrode 68 is close enough to the user's skin to detect the apparatus having been placed in the ear.

Capacitive and E-field detection methods are similar, and can use similar/same types of ear rubbers. Various methods of proximity sensing exists such as loading, transmission or absorption modes. These methods can be used to detect anything which is conductive or having dielectric properties. Thus, these methods can be used to detect a human body. Capacitive sensing methodology is a technology for detecting proximity, position, etc., based on capacitive coupling effects (loading mode). Even more reliable measurements can be based on E-field; a non-ground based methodology (transmission mode operation).

Absorption methodology could be used for same functionality as loading and transmission methodologies (such as capacitive sensing and E-Field sensing). Absorption basically means that there is a transmitter in the apparatus, which is tuned to radiate in a certain frequency. Absorption material close to it will either shift frequency or cause loss to efficiency/transmit power sensitivity. The absorption material in this case would be end user's ear/head. In principle a manufacturer could even use an existing BLUETOOTH antenna and transceiver for this methodology. This could be one example of absorption method.

Referring also to FIG. 13, features of another alternate example embodiment are shown. In this example housing part 70′ has been formed with a polymer material. The polymer material may comprise an additive activated by laser ablation. The housing part 70′ has a mount 72 which functions as a post to mount the portion 132 on. The mount 72 has a sound channel 78 therethrough. The outside surface of the mount 72 has been etched, such as by a laser direct structuring (LDS) process, and electrically conductive material 74 has been located in the resultant channel 76. In effect, the LDS process and the conductive material 74 form 3-dimensional circuitry as electrode(s) from the proximity sensor. With this type of method and structure, it makes it easy to make connection or sensor electrodes into a complex 3-D part either outside or inside of the cover part 70′.

In addition to use of proximity detection, other control methodology features could be provide in the headset including motion sensing (e.g. detecting when product is left on table or picked up), temperature (similar to on-ear detection, detecting temperature difference compared to ambient temperature), and optical sensing (e.g. detecting when product is left on table or picked up or on ear).

Unlike a conventional headset (ear mounted) which uses a clip/cradle to plug the headset into, use of the headphone/headset user experience is no longer limited to carrying a cradle with the user all the time. Without the need for a cradle, the user experience is not ruined because there is no risk that the cradle of the system is lost (the system does not need use a cradle). Without a cradle, costs are reduced and the size of the overall system is reduced. Unlike a cradle/headset system which has the headphone/headset powered ON and consumes power when it is not in the cradle or otherwise turned OFF by pressing button, the headset examples described above can automatically turn OFF when the headset is simply removed from the user's ear/head. Features of the example embodiments described above, can also be used with a clip/cradle such as described in U.S. patent application Ser. No. 13/048,083 filed Mar. 15, 2011 which is hereby incorporated by reference in its entirety. Features described herein could also be combined with features described in U.S. patent application Ser. No. 13/014,007 filed Jan. 26, 2011 which is also hereby incorporated by reference in its entirety.

Example embodiments can use automatic proximity detection methods to detect when a headphone/headset is on a user's ear or head. This detection can be used to turn the apparatus 10 ON and/or OFF, and/or another function or operation, such as send a signal to the device 14 to perform some other operation for example. Features can be used such that the headset can turn ON automatically when the headset is placed on the ear or head. Features can be used such that the headset can turn OFF automatically when the headset is removed from the ear or head. This proximity to the use's skin detection, or contact with the user's skin detection, can be used to activate a functionality, such as automatically answer an incoming call when the headphone/headset is put to the user's ear or head. For example, the headphone/headset 10 can automatically switch ON, connect to a user's telephone device 14 via link 12, and have the device 14 answer the incoming call. All this may be accomplished by merely placing the apparatus 10 in the user's ear during an incoming call to the device 14.

If the headphone/headset is already in the user's ear when a call is incoming to the device 14, the user can press the answer/end key 17 (see FIG. 1) to answer the incoming call. To reject the incoming call (if the apparatus 10 is already in the user's ear), the user could press the answer/end key 17 twice, or merely remove the headphone/headset from the ear.

To end a call (if the apparatus 10 is already in the user's ear), the user could merely remove the headset 10 from the user's ear, or press the answer/end key 17 while the headphone/headset is on the ear.

As another example, the apparatus could be programmed to allow the apparatus be to removed from the user's ear without signaling to the device 14 to end an ongoing call. For example, (while the apparatus 10 is in the user's ear during a telephone call) the user could press the answer/end key 17 one very short time to have the device 14 place the call On Hold. The user could then remove the apparatus 10 from the ear without the device 14 performing an On Hook end to the call. When the user places the apparatus 10 back in the ear, the apparatus 10 could send a signal to the device 14 to automatically take the call Off Hold, and allow the user to continue the telephone conversation.

In one type of embodiment, hardware and/or software could be configured to disregard momentary indications from the proximity detector of the proximity being too far away from the user (to thereby compensate for inaccurate proximity determinations). For example, when a signal is sent from the proximity detector to the controller 50 indicating that the apparatus 10 has been removed from the ear 26, the method/software could use a clock to wait until a predetermined amount of time elapsed before turning the apparatus 10 OFF and/or sending a signal to the device 14 to hang-up; such as 5 seconds for example. This could help to prevent an accidental ON Hook or hang-up from occurring if the apparatus 10 accidentally falls out of the user's ear.

In one type of example embodiment, there is no need for a clip/cradle or any user activated mechanism (button, sliding key, pop up button, clip with earpiece detection etc.) The examples can provide excellent ergonomics, usability and wearability to all users. Example embodiments are particularly well suited for earphones; especially in-ear and intra concha type.

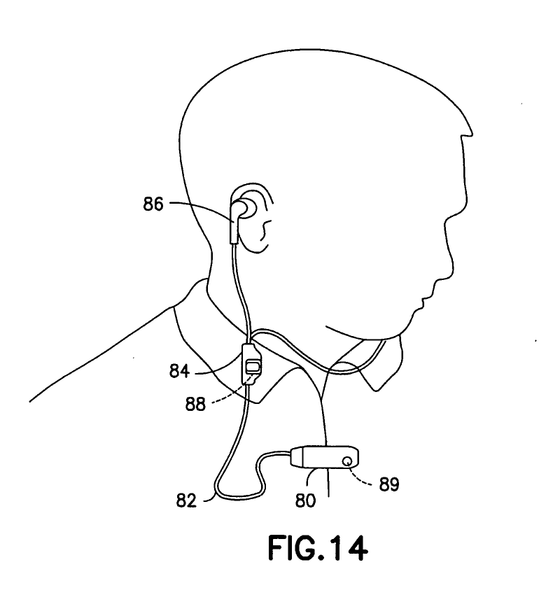

Features described herein could also be applicable for wired headsets. The detection block could be inside the wired headset or the controlling terminal/player device. An example of this is shown in FIG. 14. This example shows a music player device 80 being worn by a user. A headset 82 is connected to the device 80. The headset 82 has a volume control 84 and two earbuds 86 (only one of which is shown) for listening to stereo music. At least one of the earbuds 86 has a proximity detector electrode as described above. The proximity block, such as a capacitive block or E-Field block could be located in the volume control section 84 (as indicated by 88) or in the device 80 (as indicated by 89). When one or more of the earbuds 86 are removed from the user's ear, this could signal the device 80 to automatically turn OFF; thereby reducing use of the battery of the device 80. This type of headset and device auto ON and/or OFF feature could be used with any type of headset including an earmuff type of headset for example. The device 80 could be programmed to pause the music for a predetermined amount of time when it senses the earbud(s) being removed from the user's ear(s) and, if the proximity detector is not activated again within that amount of time, to then turn the device 80 OFF. If the proximity detector is activated within that amount of time, the device could be programmed (for example) to automatically resume playing of the music.

Different implementations can be used to make a part act as a sensor or part of a sensor system including a speaker cover or part of it with a metallic coating (conductive); an aluminum part in a speaker cover; a Laser Direct Structuring (LDS) metal coating; a full metal cover (separated from main body). Also a flex can be used for a sensor. Different ear rubber implementations can be used to make a part act as part of the sensor system such as, for example, a metal ring 2-shot molded part; a 2-shot molded plastic to plastic inner part of dielectric material (soft or hard material); or conductive rubber.

An example embodiment can be provided in an apparatus 10 comprising a housing 16 configured to support the apparatus on a head of a user; a controller 50 connected to the housing; a sound transducer 22 and/or 23 connected to the controller; and a proximity detector 54, 30 connected to the controller, where the controller is configured to perform a predetermined function based upon a signal from the proximity detector.

The housing 16 may comprise an earbud portion 32′ configured to be at least partially inserted in an ear canal 28 of the user or a concha portion 32 configured to be inserted into a concha part 24 of an ear of the user proximate the ear canal. The proximity detector may comprise a capacitive sensor 54. The proximity detector may comprise an E-field sensor 54′. When the signal indicates the proximity detector being located in close proximity to the head of the user, the predetermined function may comprise the controller 50 turning the apparatus ON in order to use the sound transducer 22 and/or 23. The predetermined function may comprises sending a signal from the apparatus 10 to a telephone 14 to answer an incoming telephone call. When the signal indicates the proximity detector being removed from close proximity to the head of the user, the predetermined function may comprises the controller turning the apparatus 10 OFF in order to not use the sound transducer. The predetermined function may comprise sending a signal from the apparatus 10 to a telephone 14 to end a telephone call. The predetermined function may comprise sending a signal from the apparatus 10 to a telephone 14 to not answer an incoming telephone call. The predetermined function could comprise sending a signal to a telephone to allow the telephone to continue an ongoing telephone call with the apparatus 10 turning OFF. Thus, the user can continue an ongoing call merely using the telephone 14 and without further use of the apparatus 10 by merely removing the apparatus 10 from the user's ear. Whether or not the telephone hangs-up the call when the user takes the apparatus 10 out of his or her ear may be user selectable via the apparatus 10 and/or the device 14. The proximity detector may comprise an Ultra Low Power Proximity (ULPP) chip 66.

An example method may comprise providing a sound transducer connected to a controller; providing a proximity detector connected to the controller; and the controller, the sound transducer and the proximity detector being configured with a housing to form an apparatus configured to be supported on a head of a user.

The housing may be formed with an earbud portion configured to be at least partially inserted in an ear canal of the user or a concha portion configured to be inserted into a concha part of an ear of the user proximate the ear canal. The proximity detector may comprise a capacitive sensor or an E-field sensor assembled with the housing to sense when the apparatus is placed on the head of the user. The proximity detector may be assembled with the housing to sense when the apparatus is taken off the head of the user. The proximity detector may comprise an Ultra Low Power Proximity (ULPP) chip which is connected to the controller.

An example method may comprise sending an electrical signal from a proximity detector to a controller, where the proximity detector is on an apparatus configured to be supported on a head of a user, and where the apparatus comprises a sound transducer; and performing at least one predetermined function by a controller of the apparatus based upon the signal from the proximity detector, where the predetermined function comprises turning the apparatus ON or OFF.

The predetermined function may comprise sending a signal from the apparatus to a telephone to answer an incoming call. The predetermined function may comprise sending a signal from the apparatus to a telephone to not answer an incoming call. The predetermined function may comprise sending a signal from the apparatus to a telephone to end a telephone call.

In one example embodiment a non-transitory program storage device may be provided, such as memory 52 or a CD-ROM or a flash drive for example, readable by a machine, tangibly embodying a program of instructions executable by the machine for performing operations, the operations comprising determining receipt of a signal by a controller of an apparatus from a proximity detector of the apparatus; and turning the apparatus ON or OFF by the controller based upon receipt of the signal by the controller, where the proximity detector and the controller are connected to a housing of the apparatus configured to be supported on a head of a user, and where the controller is configured to at least partially control a sound transducer of the apparatus.

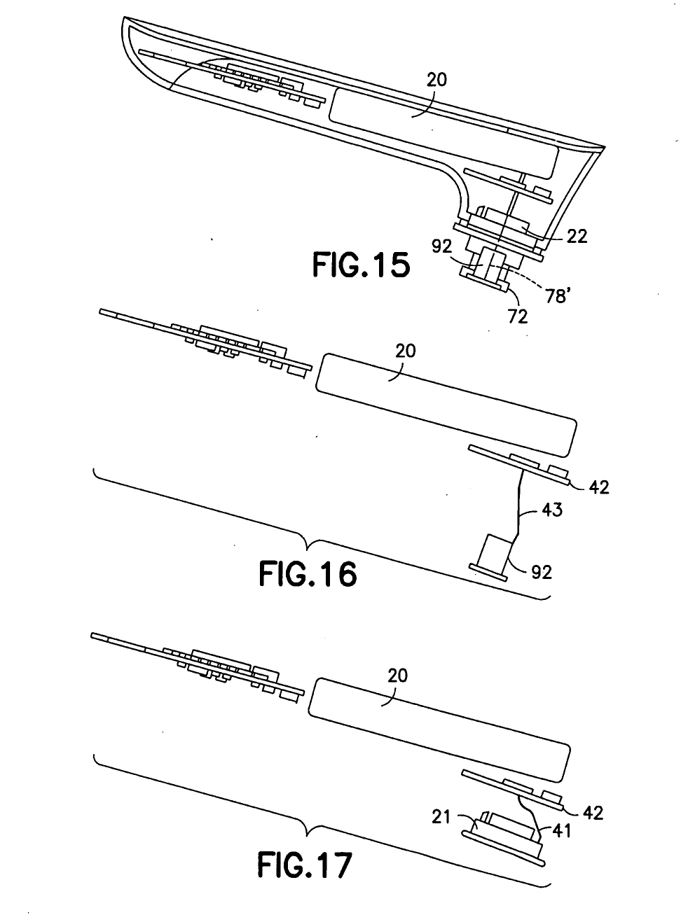

Besides the elements noted above which could be used as conductive members to detect proximity, other elements could be alternatively or additionally used. For example, referring also to FIGS. 15-17, FIG. 15 shows an example embodiment where a metal bushing 92 forms part of the sound channel 78′ and a frame for the mount 72′ of a portion 132 (see FIG. 12). The speaker 22 has a metal cover. As seen in FIG. 16, the bushing 92 can be electrically connected to printed wiring board 42 by a wire 43. As seen in FIG. 17, the metal cover 21 of the speaker 22 can be additionally or alternatively electrically connected by a wire 41 to the printed wiring board 42. The wire 41 might be a coaxial wire, for example, connected to the controller 50.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a housing configured to support the apparatus on a head of a user;
a controller connected to the housing;
a sound transducer connected to the controller; and
a proximity detector connected to the controller, where the controller is configured to perform a predetermined function based upon a signal from the proximity detector.

2. An apparatus as claimed in claim 1 where the housing comprises an earbud portion configured to be at least partially inserted in an ear canal of the user or a concha portion configured to be inserted into a concha part of an ear of the user proximate the ear canal.

3. An apparatus as claimed in claim 1 where the proximity detector comprises a capacitive sensor.

4. An apparatus as claimed in claim 1 where the proximity detector comprises an E-field sensor.

5. An apparatus as claimed in claim 1 where, when the signal indicates the proximity detector being located in close proximity to the head of the user, the predetermined function comprises the controller turning the apparatus ON in order to use the sound transducer.

6. An apparatus as claimed in claim 5 where the predetermined function comprises sending a signal from the apparatus to a telephone to answer an incoming telephone call.

7. An apparatus as claimed in claim 1 where, when the signal indicates the proximity detector being removed from close proximity to the head of the user, the predetermined function comprises the controller turning the apparatus OFF in order to not use the sound transducer.

8. An apparatus as claimed in claim 7 where the predetermined function comprises sending a signal from the apparatus to a telephone to end a telephone call.

9. An apparatus as claimed in claim 7 where the predetermined function comprises sending a signal from the apparatus to a telephone to not answer an incoming telephone call.

10. An apparatus as claimed in claim 7 where the predetermined function comprises sending a signal from the apparatus to a telephone to have the telephone continue an ongoing telephone call.

11. An apparatus as claimed in claim 1 where the proximity detector comprises an Ultra Low Power Proximity (ULPP) chip.

12. A method comprising:
providing a sound transducer connected to a controller;
providing a proximity detector connected to the controller; and
the controller, the sound transducer and the proximity detector being configured with a housing to form an apparatus configured to be supported on a head of a user.

13. A method as in claim 12 where the housing is formed with an earbud portion configured to be at least partially inserted in an ear canal of the user or a concha portion configured to be inserted into a concha part of an ear of the user proximate the ear canal.

14. A method as in claim 12 where the proximity detector comprises a capacitive sensor or an E-field sensor provided with the housing to sense when the apparatus is placed on the head of the user.

15. A method as in claim 14 where the proximity detector is provided with the housing to sense when the apparatus is taken off the head of the user.

16. A method as in claim 12 where the proximity detector comprises an-Ultra Low Power Proximity (ULPP) chip which is connected to the controller.

17. A method comprising:
sending an electrical signal from a proximity detector to a controller, where the proximity detector is on an apparatus configured to be supported on a head of a user, and where the apparatus comprises a sound transducer; and
performing at least one predetermined function by a controller of the apparatus based upon the signal from the proximity detector, where the predetermined function comprises turning the apparatus ON or OFF.

18. A method as in claim 17 where the predetermined function comprises sending a signal from the apparatus to a telephone to answer an incoming call.

19. A method as in claim 17 where the predetermined function comprises sending a signal from the apparatus to a telephone to not answer an incoming call.

20. A method as in claim 17 where the predetermined function comprises sending a signal from the apparatus to a telephone to end a telephone call.

21. A non-transitory program storage device readable by a machine, tangibly embodying a program of instructions executable by the machine for performing operations, the operations comprising:
determining receipt of a signal by a controller of an apparatus from a proximity detector of the apparatus; and
turning the apparatus ON or OFF by the controller based upon receipt of the signal by the controller, where the proximity detector and the controller are connected to a housing of the apparatus configured to be supported on a head of a user, and where the controller is configured to at least partially control a sound transducer of the apparatus.
